(19) United States
(12) Patent Application Publication
(10) Pub. No.: US 2015/0095227 A1
(43) Pub. Date: Apr. 2, 2015

(54) METHOD AND SYSTEM FOR DENYING PAYMENT AUTHORIZATION REQUESTS ASSOCIATED WITH FRAUD

(71) Applicant: MasterCard International Incorporated, Purchase, NY (US)

(72) Inventors: Scott Alan Brozek, Creve Coeur, MO (US); Troci M. Tomson, Wentzville, MO (US); Philip Rowe, Brussels (BE); Cristian Catanescu, Singapore (SG)

(73) Assignee: MasterCard International Incorporated, Purchase, NY (US)

(21) Appl. No.: 14/040,269

(22) Filed: Sep. 27, 2013

(51) Int. Cl. G06Q 20/40

(52) U.S. Cl. CPC G06Q 20/4016
USPC 705/44

(57) ABSTRACT

A computer-implemented method for denying a payment authorization request associated with fraud is described. Additionally, a computing device for denying a payment authorization request associated with fraud is described. Additionally, a computer-readable storage medium having computer-executable instructions embodied thereon for denying a payment authorization request associated with fraud is described.

### BACKGROUND

This description relates to denying a payment authorization request due to fraud, and more specifically to denying a payment authorization request at a payment network based on a previous indication by an issuer processor that a particular payment card associated with the payment authorization request is associated with fraud.

At least some known payment processing systems (“interchange networks”) process a transaction by receiving a payment authorization request from a merchant, through an acquiring bank (“acquirer”) associated with the merchant, and transmitting the authorization request message to an issuer processor (i.e., an issuer of a payment card used in a transaction, or an entity that processes transactions on behalf of an issuer). The issuer processor responds to the authorization request with an approval or denial, which the payment processing system transmits back to the acquirer, for transmission to the merchant. The issuer processor may deny the authorization request for a variety of reasons, for example if the payment card associated with the transaction has been previously identified by the issuer processor as being lost, stolen, or fraudulent (i.e., fake). In some known payment processing systems, the issuer processor maintains listings of lost, stolen, or fraudulent payment cards (“negative listings”). In other words, the negative listings are indications of payment cards that are associated with fraud. The issuer processor transmits the negative listings to the payment processing system. When the issuer processor is offline or otherwise unresponsive to a payment authorization request transmitted to the issuer processor from the payment processing system, the payment processing system may decline the payment authorization request based on the negative listings previously provided by the issuer processor. However, maintaining the negative listings may be an arduous and time-consuming process for an issuer processor. Accordingly, a system for enabling a payment processing network to decline payment authorization requests on behalf of an issuer processor without requiring the issuer processor to continuously update a set of negative listings would be beneficial.

### BRIEF DESCRIPTION OF THE DISCLOSURE

In one aspect, a computer-implemented method for denying a payment authorization request associated with fraud is described. The method is implemented using a computing device coupled to a database. The method includes receiving, by the computing device, a first payment authorization response from an issuer processor, wherein the computing device is associated with a payment network. The method additionally includes determining that the first payment authorization response indicates that a payment card identifier is associated with fraud. Additionally, the method includes storing, by the computing device, an indication in the database that the payment card identifier is associated with fraud, receiving, by the computing device, a payment authorization request directly or indirectly from a merchant, identifying, by the computing device, the payment card identifier in the received payment authorization request, determining, by the computing device, that the payment card identifier is associated with fraud based at least in part on the stored indication, and transmitting, by the computing device, a second payment authorization response to the merchant wherein the second payment authorization response includes a denial of the payment authorization request.

In another aspect, a computing device for denying a payment authorization request associated with fraud is provided. The computing device is associated with a payment network. The computing device includes a memory device and a processor coupled to the memory device. The computing device is configured to receive a first payment authorization response from an issuer processor, determine that the first payment authorization response indicates that a payment card identifier is associated with fraud, store an indication in the memory device that the payment card identifier is associated with fraud, receive a payment authorization request directly or indirectly from a merchant, identify the payment card identifier in the received payment authorization request, determine that the payment card identifier is associated with fraud based at least in part on the stored indication, and transmit a second payment authorization response to the merchant wherein the second payment authorization response includes a denial of the payment authorization request.

In yet another aspect, a computer-readable storage medium having computer-executable instructions embodied thereon for denying a payment authorization request associated with fraud is provided. When executed by a computing device having at least one processor coupled to a memory device, the computer-executable instructions cause the computing device to receive a first payment authorization response from an issuer processor, determine that the first payment authorization response indicates that a payment card identifier is associated with fraud, store an indication in the memory device that the payment card identifier is associated with fraud, receive a payment authorization request directly or indirectly from an issuer processor, identify the payment card identifier in the received payment authorization request, determine that the payment card identifier is associated with fraud based at least in part on the stored indication, and transmit a second payment authorization response to the merchant wherein the second payment authorization response includes a denial of the payment authorization request.

### BRIEF DESCRIPTION OF THE DRAWINGS

FIGS. 1-9 show example embodiments of the methods and systems described herein.

FIG. 1 is a schematic diagram illustrating an example multi-party payment card industry system for enabling ordinary payment-by-card transactions in which merchants and card issuer processors do not necessarily have a one-to-one relationship.

FIG. 2 is a simplified block diagram of an example server architecture of a system that facilitates processing of electronic payments in accordance with one embodiment of the present disclosure.

FIG. 3 is an expanded block diagram of the system architecture shown in FIG. 2 in accordance with one embodiment of the present disclosure.

FIG. 4 illustrates an example configuration of a client system shown in FIGS. 2 and 3, in accordance with one embodiment of the present disclosure.

FIG. 5 illustrates an example configuration of a server system shown in FIGS. 2 and 3, in accordance with one embodiment of the present disclosure.

FIG. 6 is a diagram of an example user interface for allowing an issuer processor to opt-in or opt-out of allowing the server system to automatically store payment card information that the issuer processor has indicated as fraud and deny payment authorization requests associated with fraud, on behalf of the issuer processor, in accordance with one embodiment of the present disclosure.

FIG. 7 is a diagram of a user interface for allowing an issuer processor to designate response codes that indicate that a payment card is associated with fraud in accordance with one embodiment of the present disclosure.

FIG. 8 is a flowchart of an example process for denying a payment authorization request associated with fraud in accordance with one embodiment of the present disclosure.

FIG. 9 is a diagram of components of one or more example computing devices that may be used in the system shown in FIG. 2 in accordance with one embodiment of the present disclosure.

### DETAILED DESCRIPTION OF THE DISCLOSURE

Embodiments of systems and methods described herein relate to denying a payment authorization request due to fraud, and more specifically to denying a payment authorization request at a payment network based on a previous indication by an issuer processor that a particular payment card associated with the payment authorization request is associated with fraud. In some instances, an issuer processor of a payment card goes “offline” or becomes unresponsive, for example due to a loss of power, a malfunction in one or more computing devices, and/or other occurrences that hinder normal functioning of the issuer processor. In such instances, a computing device associated with a payment network (“interchange network”) may operate in a “stand-in” mode in which the computing device associated with the payment network authorizes and/or denies (e.g., declines) payment authorization requests according to predetermined parameters provided by the issuer processor to the computing device. One type of parameter is whether a payment card identified in a payment authorization request is known to be associated with fraud. For example, the issuer processor may have received a notification from a cardholder associated with the identified payment card that the identified payment card has been lost or stolen. Accordingly, a payment authorization request identifying the lost or stolen card should be denied because the original cardholder is no longer in possession of the payment card. In other instances, the issuer processor may have identified a particular payment card as being fraudulent (i.e., fake). The parameters indicate that payment authorization requests identifying such fraudulent payment cards should also be denied. The parameters may identify the lost payment cards, the stolen payment cards, and the fraudulent payment cards in separate lists, or in some implementations, as a single list (i.e., in a “negative listing”).

It may be time-consuming for an issuer processor to consistently provide the computing device of the payment network with up-to-date identifications of payment cards associated with fraud. Embodiments of the systems and methods described herein enable automatically collecting payment card identifiers associated with fraud, based on payment authorization responses from an issuer processor that include one or more response codes that are indicative of fraud. The system then denies (declines) future payment authorization requests that identify payment cards associated with fraud, on behalf of the issuer processor. More specifically, in some such embodiments, the system denies a payment authorization request without transmitting the payment authorization response to the issuer processor, because the issuer processor is offline, unresponsive, or otherwise unavailable to determine whether a payment authorization response should be denied due to fraud. In some embodiments, the system enables the issuer processor to specify which response codes should trigger the computing device associated with the payment network to store an indication that a particular payment card is associated with fraud. For example, the issuer processor may specify that a previous response code from the issuer processor indicating that the payment card has been lost should be used as an indicator that a subsequent payment authorization request message identifying the payment card should be denied due to fraud. In addition, some embodiments enable an issuer processor to opt-in or opt-out of having the payment network automatically store payment card information that the issuer processor has indicated as fraud. For example, the issuer processor may opt-in or opt-out of having the payment network deny future payment authorization requests based on previous response codes from the issuer processor, for all payment cards issued by the associated issuer, or for a subset of such payment cards. Additionally, some embodiments purge stored indications of payment cards being associated with fraud after a predetermined time period (e.g., 180 days) or on a predetermined date.

The methods and systems described herein may be implemented using computer programming or engineering techniques including computer software, firmware, hardware or any combination or subset thereof, wherein the technical effect may include at least one of: (a) receiving, by a computing device, a first payment authorization response from an issuer processor, wherein the computing device is associated with a payment network; (b) determining that the first payment authorization response indicates that a payment card identifier is associated with fraud; (c) storing, by the computing device, an indication in a database that the payment card identifier is associated with fraud; (d) receiving, by the computing device, a payment authorization request directly or indirectly from a merchant; (e) identifying, by the computing device, the payment card identifier in the received payment authorization request; (f) determining, by the computing device, that the payment card identifier is associated with fraud based at least in part on the stored indication; and (g) transmitting, by the computing device, a second payment authorization response to the merchant wherein the second payment authorization response includes a denial of the payment authorization request.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, smartphones, personal digital assistants (PDAs), key fobs, and/or computers. Each type of transactions card can be used as a method of payment for performing a transaction.

In one embodiment, a computer program is provided, and the program is embodied on a computer-readable medium. In an example embodiment, the system is executed on a single computer system, without requiring a connection to a sever computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application to processing financial transaction data by a third party in industrial, commercial, and residential applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

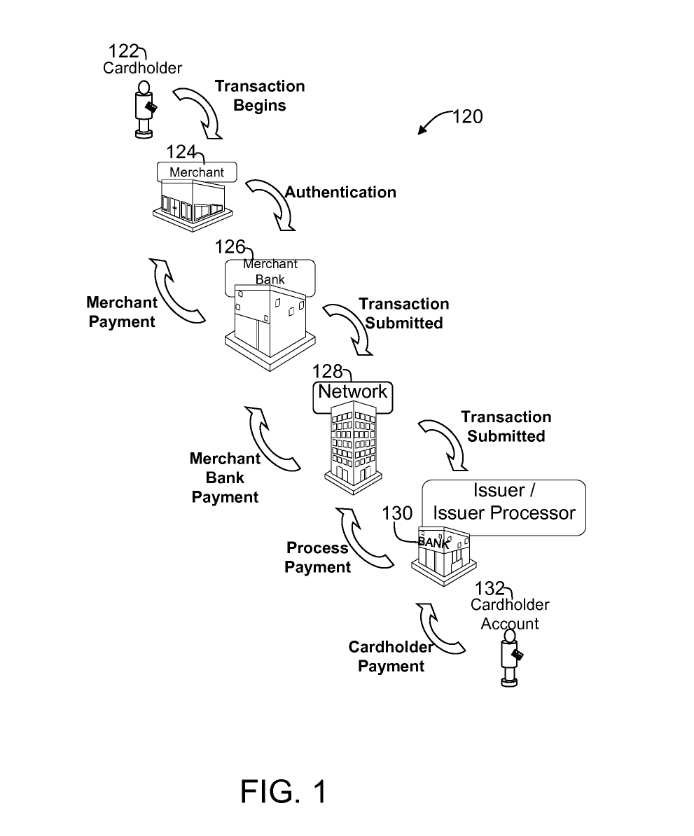

FIG. 1 is a schematic diagram illustrating an example multi-party payment card system 120 for enabling ordinary payment-by-card transactions in which merchants and card issuer processors do not necessarily have a one-to-one relationship. The present disclosure relates to payment card system 120, such as a credit card payment system using the MasterCard® payment card system payment network 128 (also referred to as an “interchange” or “interchange network”). MasterCard® payment card system payment network 128 is a proprietary communications standard promulgated by MasterCard International Incorporated® for the exchange of financial transaction data between financial institutions that are members of MasterCard International Incorporated®. (MasterCard is a registered trademark of MasterCard International Incorporated located in Purchase, N.Y.).

In payment card system 120, a financial institution such as an issuer issues a payment account card, such as a credit card account or a debit card account, to a cardholder 122, who uses the payment account card to tender payment for a purchase from a merchant 124. To accept payment with the payment account card, merchant 124 must normally establish an account with a financial institution that is part of the financial payment system. This financial institution is usually called the “merchant bank” or the “acquiring bank” or “acquirer bank” or simply “acquirer”. When a cardholder 122 tenders payment for a purchase with a payment account card (also known as a financial transaction card), merchant 124 requests authorization from acquirer 126 for the amount of the purchase. The request may be performed over the telephone, but is usually performed through the use of a point-of-interaction terminal, which reads the cardholder's account information from the magnetic stripe on the payment account card and communicates electronically with the transaction processing computers of acquirer 126. Alternatively, acquirer 126 may authorize a third party to perform transaction processing on its behalf. In this case, the point-of-interaction terminal will be configured to communicate with the third party. Such a third party is usually called a “merchant processor” or an “acquiring processor.”

Using payment card system payment network 128, the computers of acquirer 126 or the merchant processor will communicate with the computers of issuer processor 130, to determine whether the cardholder's account 132 is in good standing and whether the purchase is covered by the cardholder's available credit line or account balance. Based on these determinations, the request for authorization will be declined (“denied”) or accepted. If the request is accepted, an authorization code is issued to merchant 124.

When a request for authorization is accepted, the available credit line or available balance of cardholder's account 132 is decreased. Normally, a charge is not posted immediately to a cardholder's account because bankcard associations, such as MasterCard International Incorporated®, have promulgated rules that do not allow a merchant to charge, or “capture,” a transaction until goods are shipped or services are delivered. When a merchant ships or delivers the goods or services, merchant 124 captures the transaction by, for example, appropriate data entry procedures on the point-of-interaction terminal. If a cardholder cancels a transaction before it is captured, a “void” is generated. If a cardholder returns goods after the transaction has been captured, a “credit” is generated.

For debit card transactions, when a request for authorization is approved by the issuer processor, the cardholder's account 132 is decreased. Normally, a charge is posted immediately to cardholder's account 132. The bankcard association then transmits the approval to the acquiring processor for distribution of goods/services, or information or cash in the case of an ATM.

After a transaction is captured, the transaction is settled between merchant 124, acquirer 126, and issuer processor 130. Settlement refers to the transfer of financial data or funds between the merchant's account, acquirer 126, and issuer processor 130 related to the transaction. Usually, transactions are captured and accumulated into a “batch,” which is settled as a group.

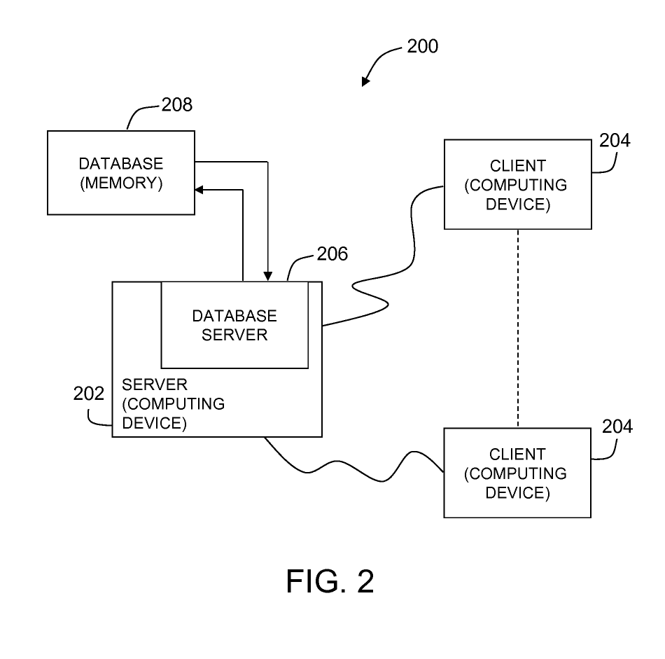

FIG. 2 is a simplified block diagram of an example system 200 in accordance with one embodiment of the present disclosure. In the example embodiment, system 200 includes a server system 202 and a plurality of client subsystems, also referred to as client systems 204 or client computing devices, connected to server system 202. In one embodiment, client systems 204 are computers including a web browser, such that server system 202 is accessible to client systems 204 using the Internet. Client systems 204 are interconnected to the Internet through many interfaces including a network, such as a local area network (LAN) and/or a wide area network (WAN), dial-in connections, cable modems, wireless-connections, and special high-speed ISDN lines. Client systems 204 may be any device capable of interconnecting to the Internet including a web-based phone, personal digital assistant (PDA), or other web-connectable equipment. A database server 206 is connected to a database 208 containing information on a variety of matters, as described below in greater detail. In one embodiment, database 208 is stored on server system 202 and may be accessed by potential users at one of client systems 204 by logging onto server system 202 through one of client systems 204. In any alternative embodiment, database 208 is stored remotely from server system 202 and may be non-centralized. Server system 202 could be any type of computing device configured to perform the steps described herein.

As discussed below, identifiers of payment cards designated as being lost, stolen, fraudulent, or otherwise associated with fraud, are stored within database 208. Additionally, database 208 may store opt-in and/or opt-out indicators associated with issuer processors, for example issuer processor 130. Database 208 may also store dates (“purge dates”) on which to delete identifiers of one or more payment cards designated as being associated with fraud.

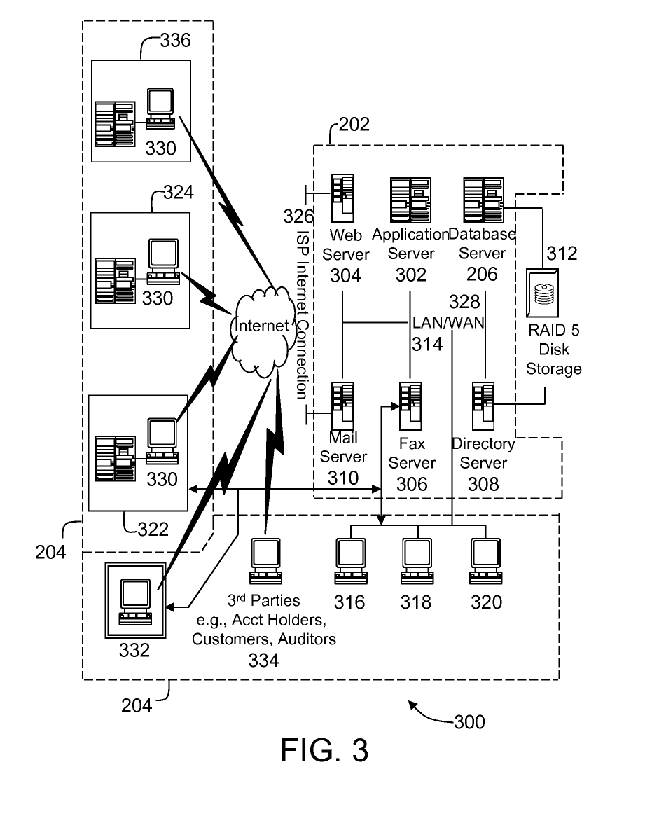

FIG. 3 is an expanded block diagram of an example embodiment of a server architecture 300 in accordance with one embodiment of the present disclosure. Server architecture 300 includes server system 202 and client systems 204. Server system 202 further includes database server 206, an application server 302, a web server 304, a fax server 306, a directory server 308, and a mail server 310. A disk storage unit 312 is coupled to database server 206 and directory server 308. Servers 206, 302, 304, 306, 308, and 310 are coupled in a local area network (LAN) 314. In addition, a system administrator's workstation 316, a user workstation 318, and a supervisor's workstation 320 are coupled to LAN 314. Alternatively, workstations 316, 318, and 320 are coupled to LAN 314 using an Internet link or are connected through an Intranet.

Each workstation, 316, 318, and 320, is a personal computer having a web browser. Although the functions performed at the workstations typically are illustrated as being performed at respective workstations 316, 318, and 320, such functions can be performed at one of many personal computers coupled to LAN 314. Workstations 316, 318, and 320 are illustrated as being associated with separate functions only to facilitate an understanding of the different types of functions that can be performed by individuals having access to LAN 314.

Server system 202 is configured to be communicatively coupled to various entities, including acquirers 322 and issuer processors 324, and to third parties, e.g., auditors, 334 using an Internet connection 326. Server system 202 is also communicatively coupled with a merchant 336. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 328, local area network 314 could be used in place of WAN 328.

In the example embodiment, any authorized individual or entity having a workstation 330 may access system 300. At least one of the client systems includes a manager workstation 332 located at a remote location. Workstations 330 and 332 include personal computers having a web browser. Also, workstations 330 and 332 are configured to communicate with server system 202. Furthermore, fax server 306 communicates with remotely located client systems, including a client system 332, using a telephone link. Fax server 306 is configured to communicate with other client systems 316, 318, and 320 as well.

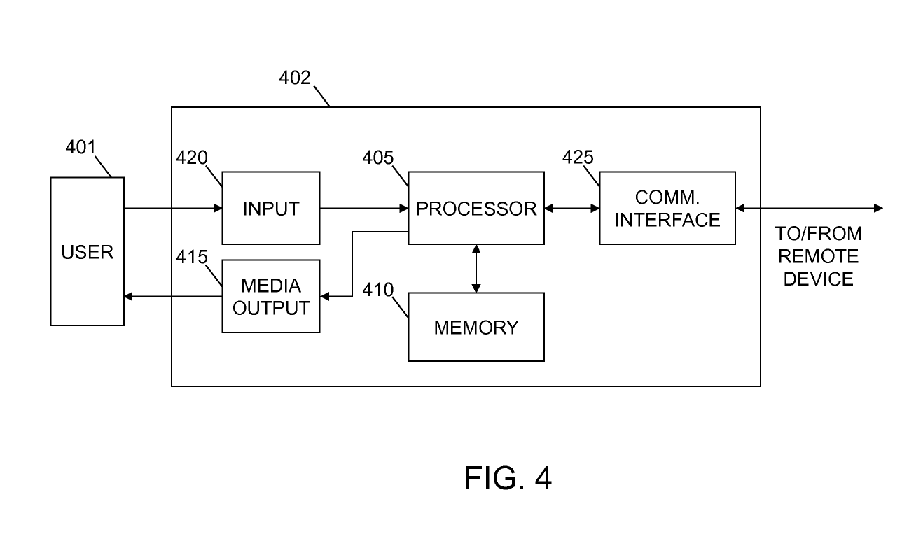

FIG. 4 illustrates an example configuration of a cardholder computing device 402 operated by a cardholder 401. Cardholder computing device 402 may include, but is not limited to, client systems (“client computing devices”) 204, 316, 318, and 320, workstation 330, and manager workstation 332 (shown in FIG. 3).

Cardholder computing device 402 includes a processor 405 for executing instructions. In some embodiments, executable instructions are stored in a memory area 410. Processor 405 may include one or more processing units (e.g., in a multi-core configuration). Memory area 410 is any device allowing information such as executable instructions and/or other data to be stored and retrieved. Memory area 410 may include one or more computer-readable media.

Cardholder computing device 402 also includes at least one media output component 415 for presenting information to cardholder 401. Media output component 415 is any component capable of conveying information to cardholder 401. In some embodiments, media output component 415 includes an output adapter such as a video adapter and/or an audio adapter. An output adapter is operatively coupled to processor 405 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, cardholder computing device 402 includes an input device 420 for receiving input from cardholder 401. Input device 420 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 415 and input device 420.

Cardholder computing device 402 may also include a communication interface 425, which is communicatively couplable to a remote device such as server system 202 or a web server operated by a merchant. Communication interface 425 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 410 are, for example, computer-readable instructions for providing a user interface to cardholder 401 via media output component 415 and, optionally, receiving and processing input from input device 420. A user interface may include, among other possibilities, a web browser and client application. Web browsers enable cardholders, such as cardholder 401, to display and interact with media and other information typically embedded on a web page or a website from server system 202 or a web server associated with a merchant. A client application allows cardholder 401 to interact with a server application from server system 202 or a web server associated with a merchant.

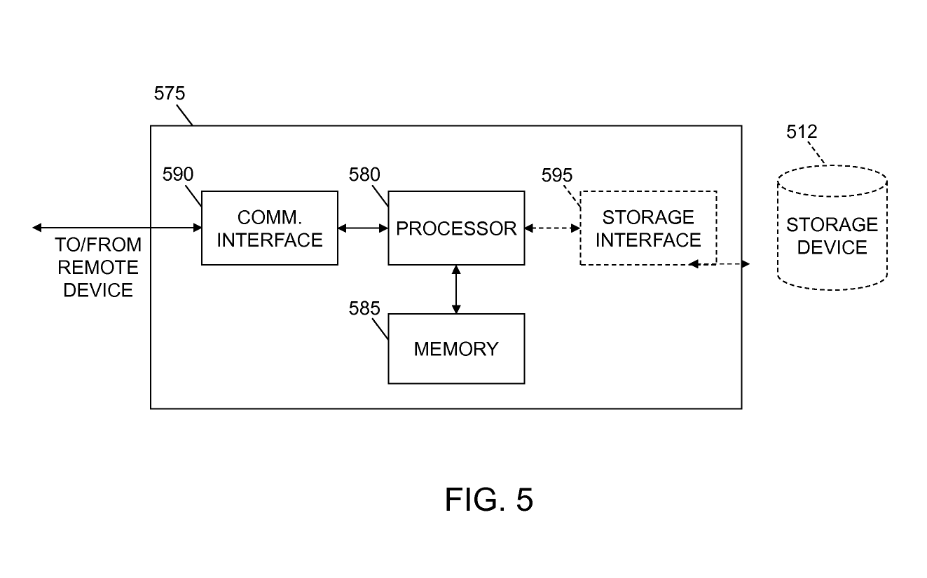

FIG. 5 illustrates an example configuration of a server computing device 575 such as server system 202 (shown in FIGS. 2 and 3). Server computing device 575 may include, but is not limited to, database server 206, application server 302, web server 304, fax server 306, directory server 308, and mail server 310.

Server computing device 575 includes a processor 580 for executing instructions. Instructions may be stored in a memory area 585, for example. Processor 580 may include one or more processing units (e.g., in a multi-core configuration).

Processor 580 is operatively coupled to a communication interface 590 such that server computing device 575 is capable of communicating with a remote device such as cardholder computing device 402 or another server computing device 575. For example, communication interface 590 may receive requests from client systems 204 via the Internet, as illustrated in FIGS. 2 and 3.

Processor 580 may also be operatively coupled to a storage device 512. Storage device 512 is any computer-operated hardware suitable for storing and/or retrieving data. In some embodiments, storage device 512 is integrated in server computing device 575. For example, server computing device 575 may include one or more hard disk drives as storage device 512. In other embodiments, storage device 512 is external to server computing device 575 and may be accessed by a plurality of server computing devices 575. For example, storage device 512 may include multiple storage units such as hard disks or solid state disks in a redundant array of inexpensive disks (RAID) configuration. Storage device 512 may include a storage area network (SAN) and/or a network attached storage (NAS) system.

In some embodiments, processor 580 is operatively coupled to storage device 512 via a storage interface 595. Storage interface 595 is any component capable of providing processor 580 with access to storage device 512. Storage interface 595 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 580 with access to storage device 512.

Memory areas 410 and 585 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

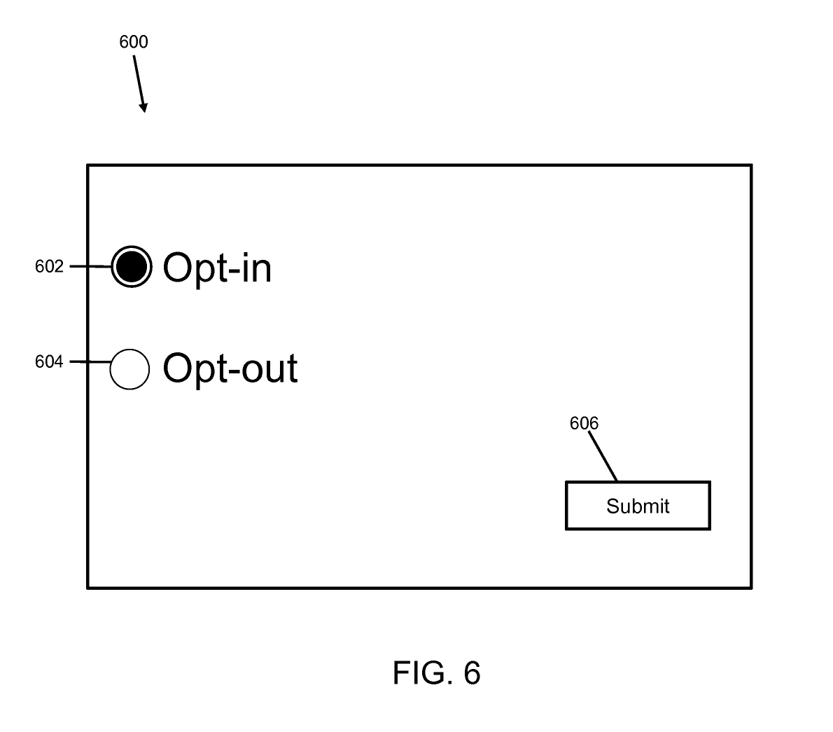

FIG. 6 is a diagram of an example user interface 600 for allowing at least one issuer processor (e.g., issuer processor 130) to opt-in or opt-out of allowing server system 202 to automatically store payment card information that issuer processor 130 has indicated as fraud and deny payment authorization requests associated with fraud, on behalf of issuer processor 130. Server system 202 may transmit instructions and data to computing device 324 of issuer processor 130 for displaying user interface 600. User interface 600 includes a first option button 602 and a second option button 604. If first option button 602 is selected and a submit button 606 is activated, server system 202 receives an indication from computing device 324 that issuer processor 130 has opted-in to allowing server system 202 to automatically store payment card information that issuer processor 130 has indicated as fraud. More specifically, issuer processor 130 opts-in to have server system 202 (i) determine, from one or more payment authorization responses transmitted from computing device 324 that the payment card identified in a corresponding payment authorization request is associated with fraud and (ii) subsequently deny future payment authorization requests for any such payment cards associated with fraud, without requiring a payment authorization response from issuer processor 130. For example, server system 202 may identify a response code from issuer processor 130 that indicates that the payment card has been reported as lost, stolen, or fraudulent, and thereafter deny or decline payment authorization requests associated with the payment card.

Alternatively, if second option button 604 is selected and submit button 606 is activated, server system 202 receives an indication from computing device 324 that issuer processor 130 opts-out of allowing server system 202 to perform the service described above. In some implementations, server system 202 stores a default indicator of whether issuer processor 130 opts-in or opts-out of the service, and updates the indicator if and when computing device 324 transmits an indication to server system 202 as described above. In some implementations, server system 202 enables issuer processor 130 to specify a range of payment card numbers for which to apply the above-described service to. In such implementations, server system 202 stores the specified range in database 208 in association with issuer processor 130.

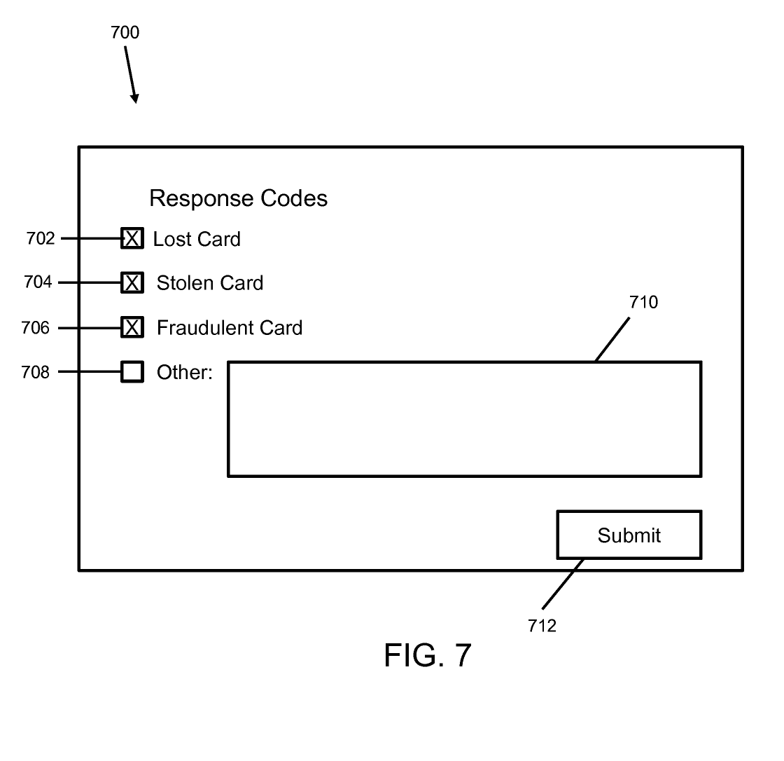

FIG. 7 is a diagram of an example user interface 700 for allowing at least one issuer processor (e.g., issuer processor 130) to designate response codes to indicate that a payment card is associated with fraud, in accordance with one embodiment of the present disclosure. Server system 202 may transmit instructions and data to computing device 324 of issuer processor 130 for displaying user interface 700. User interface 700 includes a first option button 702, a second option button 704, a third option button 706, and a fourth option button 708. User interface 700 additionally includes a text field 710 and a submit button 712.

If first option button 702 is selected when submit button 712 is activated, server system 202 receives an indication from computing device 324 that a response code from issuer processor 130 indicating that a payment card has been lost should be treated as an indicator that the payment card is associated with fraud. Likewise, if second option button 704 is selected when submit button 714 is activated, server system 202 receives an indication from computing device 324 that a response code from issuer processor 130 indicating that a payment card has been stolen should be treated as an indicator that the payment card is associated with fraud. Similarly, if third option button 706 is selected when submit button 714 is activated, server system 202 receives and indication from computing device 324 that a response code from issuer processor 130 indicating that a payment card has been determined to be fraudulent (i.e., fake) should be treated as an indicator that the payment card is associated with fraud. If fourth option button 708 is selected and a specification of one or more response codes is included in text field 710, then server system 202 receives an indication from computing device 324 that the one or more specified response codes should be treated as indicators that the payment card is associated with fraud. In some implementations, server system 202 stores the specified response codes in database 208 in association with issuer processor 130.

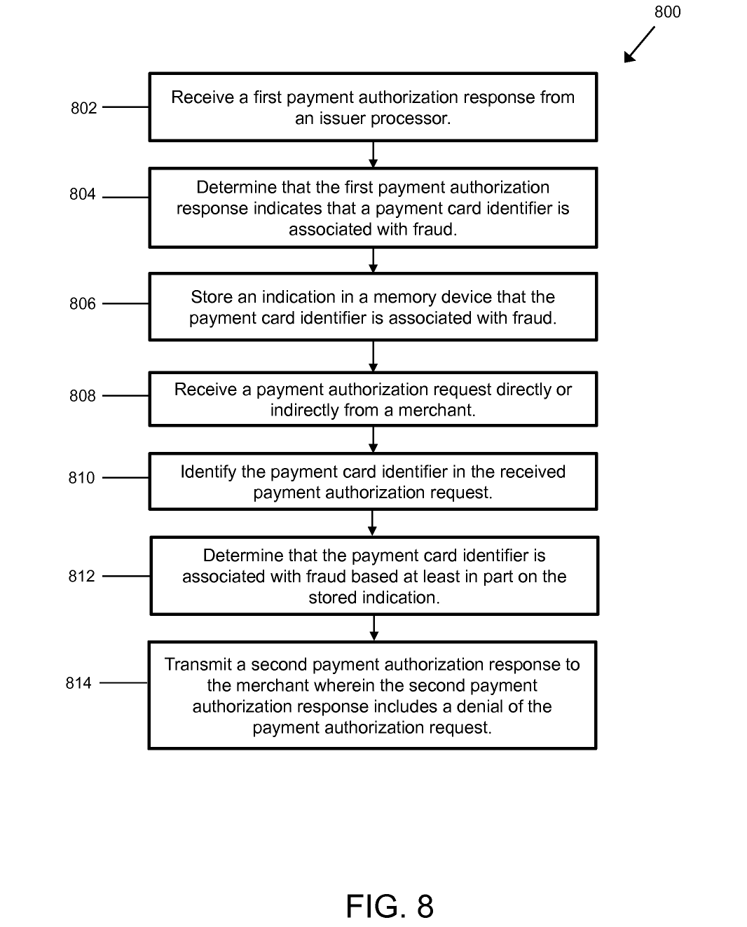

FIG. 8 is a flowchart of an example process 800 for denying a payment authorization request associated with fraud, in accordance with one embodiment of the present disclosure. Process 800 may be implemented by a computing device, for example server system 202. Initially, server system 202 receives 802 a first payment authorization response from an issuer processor (e.g., issuer processor 130). For example, server system 202 may have previously transmitted a payment authorization request to issuer processor 130, in which a payment card is identified, and server system 202 subsequently receives 802 a corresponding payment authorization response from issuer processor 130. Next, server system 202 determines 804 that the first payment authorization response indicates that the payment card identifier is associated with fraud. For example, server system 202 may retrieve from database 208 an indication that a payment authorization response from issuer processor 130 with a response code indicating that the payment card was stolen should be treated as an indication that the identified payment card is associated with fraud. Next, server system 202 stores 806 an indication in a memory device coupled to server system (e.g., database 208) that the payment card identifier is associated with fraud. Next, server system 202 receives 808, in a subsequent transaction, a payment authorization request directly or indirectly from a merchant (e.g., merchant 124). Next, server system 202 identifies 810 the payment card identifier in the received payment authorization request. Next, server system 202 determines 812 that the payment card identifier is associated with fraud based at least in part on the stored indication. Next, server system 202 transmits a second payment authorization response (i.e., a subsequent payment authorization response) to the merchant (e.g., merchant 124). The second payment authorization response includes a denial (“decline”) of the payment authorization request.

In some implementations, server system 202 initially attempts to transmit a communication to the issuer processor and subsequently determines that the issuer processor is offline, prior to or as part of determining 812 that the payment card identifier is associated with fraud based on the stored indication and transmitting 814 the second payment authorization response. Additionally, in some implementations, attempting to transmit a communication to the issuer processor includes transmitting the payment authorization request to the issuer processor. In some implementations, determining that the issuer processor is offline includes determining that the issuer processor did not receive the communication and/or determining that the issuer processor did not transmit a response to the communication within a predetermined time period.

Additionally, in some implementations, server system 202 transmits a notification to the issuer processor that the payment authorization request was denied due to the stored indication. Further, in some implementations, in transmitting 814 the second payment authorization response, server system 202 includes a fraud indicator in the second payment authorization response, thereby notifying acquirer 126 and merchant 124 that the authorization request was denied (“declined”) due to fraud. Additionally, in some implementations, server system 202 stores an opt-in indicator in association with issuer processor 130. In storing 806 an indication that the payment card identifier is associated with fraud and determining 812 that the payment card identifier is associated with fraud based at least in part on the stored indication, server system 202 determines that the opt-in indicator has been stored in associated with issuer processor 130. Conversely, server system 202 may avoid performing steps 806, 812, and 814 if database 208 instead includes an opt-out indicator in association with issuer processor 130.

In some implementations, server system 202 stores a predetermined purge date in database 208 and removes (e.g., deletes) the stored indication from database 208 on the purge date. Additionally, in some implementations, in storing 806 the indication that the payment card identifier is associated with fraud, server system 202 stores the payment card identifier in at least one of a list of payment card identifiers that are associated with fraudulent payment cards, a list of payment card identifiers that are associated with stolen payment cards, and a list of payment card identifiers that are associated with lost payment cards. In some implementations, the server system 202 stores a single list (e.g., a “negative listing”) for payment card identifiers associated with fraud.

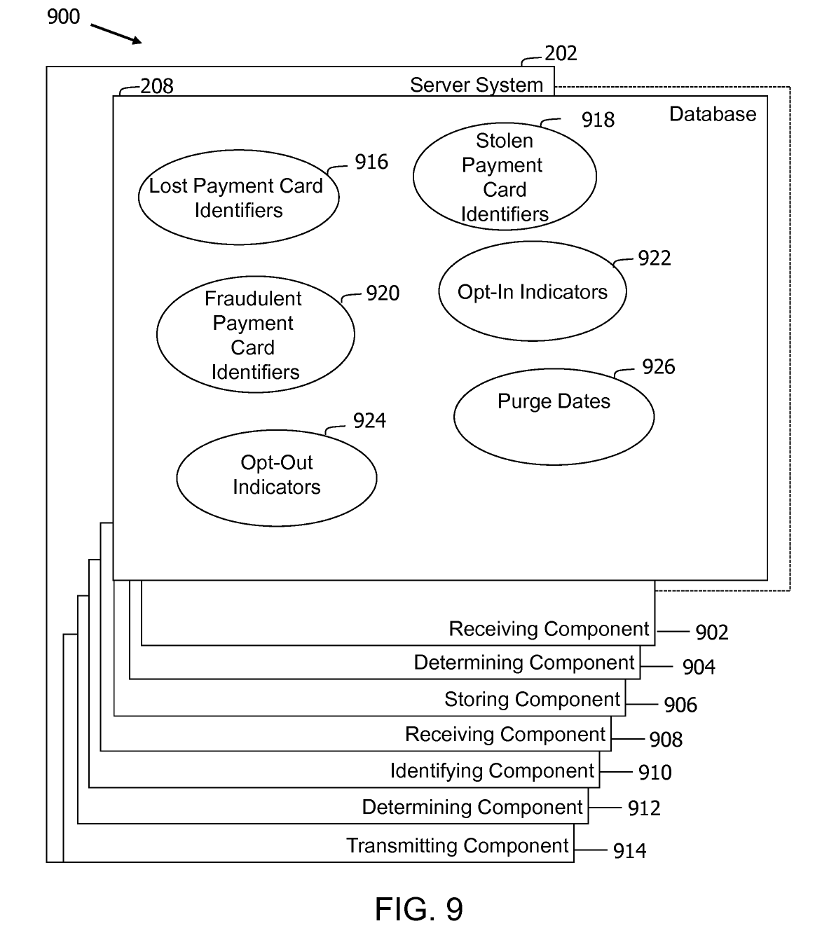

FIG. 9 is a diagram 900 of components of one or more example computing devices, for example, server system 202, that may be used in embodiments of the described systems and methods. FIG. 9 further shows a configuration of database 208 (FIG. 2). Database 208 is coupled to several separate components within server system 202, which perform specific tasks.

Server system 202 includes a receiving component 902 for receiving a first payment authorization from an issuer processor. Server system 202 also includes a determining component 904 for determining that the first payment authorization response indicates that a payment card identifier is associated with fraud. Server system 202 additionally includes a storing component 906 for storing an indication in a memory device (e.g. database 208) that the payment card identifier is associated with fraud. Server system 202 additionally includes a receiving component 908 for receiving a payment authorization request directly or indirectly from a merchant. Additionally, server system 202 includes an identifying component 910 for identifying the payment card identifier in the received payment authorization request. Server system 202 also includes a determining component 912 for determining that the payment card identifier is associated with fraud based at least in part on the stored indication. Additionally, server system 202 includes a transmitting component 914 for transmitting a second payment authorization response to the merchant wherein the second payment authorization response includes a denial of the payment authorization request.

In an example embodiment, database 208 is divided into a plurality of sections, including but not limited to, a lost payment card identifiers section 916, a stolen payment card identifiers section 918, a fraudulent payment card identifiers section 920, an opt-in indicators section 922, an opt-out indicators section 924, and a purge dates section 926. These sections within databases 208 are interconnected to retrieve and store information in accordance with the functions and processes described above.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 405, 580, including RAM memory, ROM memory, EPROM memory, EEPROM memory, and non-volatile RAM (NVRAM) memory. The above memory types are example only, and are thus not limiting as to the types of memory usable for storage of a computer program.

As will be appreciated based on the foregoing specification, the above-discussed embodiments of the disclosure may be implemented using computer programming or engineering techniques including computer software, firmware, hardware or any combination or subset thereof. Any such resulting computer program, having computer-readable and/or computer-executable instructions, may be embodied or provided within one or more computer-readable media, thereby making a computer program product, i.e., an article of manufacture, according to the discussed embodiments of the disclosure. These computer programs (also known as programs, software, software applications or code) include machine instructions for a programmable processor, and can be implemented in a high-level procedural and/or object-oriented programming language, and/or in assembly/machine language. As used herein, the terms “machine-readable medium,” “computer-readable medium,” and “computer-readable media” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium,” “computer-readable medium,” and “computer-readable media,” however, do not include transitory signals (i.e., they are “non-transitory”). The term “machine-readable signal” refers to any signal used to provide machine instructions and/or data to a programmable processor.

As compared to known systems and methods for denying payment authorization requests due to fraud, on behalf of an issuer processor, the above-described embodiments of a methods and systems relieve issuer processors of manually updating a listing of payment cards associated with fraud and providing the listing to a payment network on a continuous basis.

This written description uses examples, including the best mode, to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-implemented method for denying a payment authorization request associated with fraud, said method implemented using a computing device coupled to a database, said method comprising:
receiving, by the computing device, a first payment authorization response from an issuer processor, wherein the computing device is associated with a payment network;
determining, by the computing device, that the first payment authorization response indicates that a payment card identifier is associated with fraud;
storing, by the computing device, an indication in the database that the payment card identifier is associated with fraud, in response to determining that the first payment authorization response indicates that the payment card identifier is associated with fraud;
receiving, by the computing device, a payment authorization request, directly or indirectly, from a merchant;
identifying, by the computing device, the payment card identifier in the received payment authorization request;
determining, by the computing device, that the payment card identifier is associated with fraud based at least in part on the stored indication; and
transmitting, by the computing device, a second payment authorization response to the merchant wherein the second payment authorization response includes a denial of the payment authorization request.

2. The computer-implemented method of claim 1, wherein determining that the payment card identifier is associated with fraud further comprises:
attempting to transmit a communication to the issuer processor; and
determining that the issuer processor is offline.

3. The computer-implemented method of claim 2, wherein attempting to transmit a communication comprises transmitting the payment authorization request to the issuer processor.

4. The computer-implemented method of claim 2, wherein determining that the issuer processor is offline comprises at least one of determining that the issuer processor did not receive the communication and determining that the issuer processor did not transmit a response to the communication within a predetermined time period.

5. The computer-implemented method of claim 1, further comprising transmitting a notification to the issuer processor that the payment authorization request was denied due to the stored indication.

6. The computer-implemented method of claim 1, wherein transmitting the second payment authorization response further comprises including a fraud indicator in the second payment authorization response.

7. The computer-implemented method of claim 1, further comprising:
storing an opt-in indicator in association with the issuer processor; and
wherein determining that the payment card identifier is associated with fraud based at least in part on the stored indication further comprises determining that the opt-in indicator has been stored in association with the issuer processor.

8. The computer-implemented method of claim 1, further comprising:
storing a predetermined purge date in the database; and
removing the stored indication from the database on the purge date.

9. The computer-implemented method of claim 1, wherein storing the indication that the payment card identifier is associated with fraud further comprises storing the payment card identifier in at least one of a list of payment card identifiers that are associated with fraudulent payment cards, a list of payment card identifiers that are associated with stolen payment cards, and a list of payment card identifiers that are associated with lost payment cards.

10. A computing device for denying a payment authorization request associated with fraud, said computing device associated with a payment network, said computing device comprising a memory device and a processor coupled to the memory device, said computing device configured to:
receive a first payment authorization response from an issuer processor;
determine that the first payment authorization response indicates that a payment card identifier is associated with fraud;
store an indication in said memory device that the payment card identifier is associated with fraud, in response to determining that the first payment authorization response indicates that the payment card identifier is associated with fraud;
receive a payment authorization request, directly or indirectly, from a merchant;
identify the payment card identifier in the received payment authorization request;
determine that the payment card identifier is associated with fraud based at least in part on the stored indication; and
transmit a second payment authorization response to the merchant wherein the second payment authorization response includes a denial of the payment authorization request.

11. The computing device of claim 10, further configured to:
attempt to transmit a communication to the issuer processor; and
determine that the issuer processor is offline.

12. The computing device of claim 11, further configured to attempt to transmit a communication by transmitting the payment authorization request to the issuer processor.

13. The computing device of claim 11, further configured to determine that the issuer processor is offline by at least one of determining that the issuer processor did not receive the communication and determining that the issuer processor did not transmit a response to the communication within a predetermined time period.

14. The computing device of claim 10, further configured to transmit a notification to the issuer processor that the payment authorization request was denied due to the stored indication.

15. The computing device of claim 10, further configured to include a fraud indicator in the second payment authorization response.

16. The computing device of claim 10, further configured to:
store an opt-in indicator in association with the issuer processor; and
determine that the payment card identifier is associated with fraud based at least in part on the stored indication by additionally determining that the opt-in indicator has been stored in association with the issuer processor.

17. The computing device of claim 10, further configured to:
store a predetermined purge date in the database; and
remove the stored indication from the database on the purge date.

18. The computing device of claim 10, further configured to store the indication that the payment card identifier is associated with fraud by storing the payment card identifier in at least one of: a list of payment card identifiers that are associated with fraudulent payment cards, a list of payment card identifiers that are associated with stolen payment cards, and a list of payment card identifiers that are associated with lost payment cards.

19. A computer-readable storage medium having computer-executable instructions embodied thereon for denying a payment authorization request associated with fraud, wherein when executed by a computing device having at least one processor coupled to a memory device, the computer-executable instructions cause the computing device to:
receive a first payment authorization response from an issuer processor;
determine that the first payment authorization response indicates that a payment card identifier is associated with fraud;
store an indication in the memory device that the payment card identifier is associated with fraud, in response to determining that the first payment authorization response indicates that the payment card identifier is associated with fraud;
receive a payment authorization request, directly or indirectly, from a merchant;
identify the payment card identifier in the received payment authorization request;
determine that the payment card identifier is associated with fraud based at least in part on the stored indication; and
transmit a second payment authorization response to the merchant wherein the second payment authorization response includes a denial of the payment authorization request.

20. The computer-readable storage medium of claim 19, wherein the computer-executable instructions further cause the computing device to:
attempt to transmit a communication to the issuer processor; and
determine that the issuer processor is offline.

21. The computer-implemented method of claim 1, further comprising determining that the payment card identifier is associated with fraud after identifying the payment card identifier in the received payment authorization request and before transmitting the second payment authorization response to the merchant.
